(19) United States
(12) Patent Application Publication
(10) Pub. No.: US 2026/0351200 A1
(43) Pub. Date: Nov. 5, 2026

(54) Electronic Device

(71) Applicant: Samsung Display Co., Ltd., Yongin-si (KR)

(72) Inventor: Junwon Choi, Yongin-si (KR)

(73) Assignee: Samsung Display Co., Ltd., Yongin-si (KR)

(21) Appl. No.: 19/550,598

(22) Filed: Feb. 26, 2026

(30) Foreign Application Priority Data
May 2, 2025 (KR) 10-2025-0058354

(51) Int. Cl. G09G 3/3275; G09G 3/3233; G09G 3/3266

(52) U.S. Cl. CPC G09G 3/3275; G09G 3/3233; G09G 3/3266; G09G 2300/0819; G09G 2300/0842; G09G 2310/0286; G09G 2310/04; G09G 2330/021

(57) ABSTRACT

An electronic device is provided that includes a display panel and a data driving circuit. A display area and a non-display area are defined in the display panel. In some aspects, the display panel includes a plurality of pixels, a scan driving circuit spaced apart from the data driving circuit in a first direction, a plurality of scan lines extending in the first direction and arranged in a second direction intersecting the first direction, a plurality of data lines extending in the second direction and arranged in the first direction, and a plurality of data supply lines extending in parallel with the first direction and electrically connected in a one-to-one correspondence with the plurality of data lines, a first scan control line electrically connected to one end of the scan driving circuit, and a second scan control line electrically connected to the other end of the scan driving circuit.

### CROSS-REFERENCE TO RELATED APPLICATIONS

This application claims priority to and the benefit of Korean Patent Application No. 10-2025-0058354, filed on May 2, 2025, the disclosure of which is incorporated by reference herein in its entirety.

### TECHNICAL FIELD

The present disclosure relates to an electronic device with reduced manufacturing cost.

### BACKGROUND

Multimedia electronic devices such as televisions, mobile phones, tablet computers, navigation systems, game consoles, and the like include a display device for displaying images. The display device includes a display panel and a display panel driver. The display panel driver includes a scan driving circuit that provides a scan signal to each of a plurality of scan lines and a data driving circuit that provides a data voltage to each of a plurality of data lines.

Accordingly, there is a need for electronic devices with lower manufacturing costs.

### BRIEF SUMMARY

The disclosure is intended to solve problems including problems associated with the cost of manufacturing electronic devices. The present disclosure describes an electronic device, capable of being produced with fewer driver circuits to reduce manufacturing cost. More particularly, the present disclosure relates to an electronic device with fewer driver circuits for outputting voltages, thereby reducing cost associated with manufacturing such a device.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some aspects, an electronic device is provided that comprises: a display panel in which a display area and a non-display area are defined, and a data driving circuit electrically connected to the display panel, wherein the display panel includes a plurality of pixels arranged in the display area, a scan driving circuit arranged in the non-display area and spaced apart from the data driving circuit in a first direction, a plurality of scan lines extending from the scan driving circuit in the first direction, the plurality of scan lines being arranged so that each scan line of the plurality of scan lines is spaced apart in a second direction intersecting the first direction, a plurality of data lines extending in the second direction, the plurality of data lines being arranged so that each data line of the plurality of data lines is spaced apart in the first direction, a plurality of data supply lines extending in parallel with the first direction and electrically connected in a one-to-one correspondence with the plurality of data lines, a first scan control line electrically connected to one end of the scan driving circuit, and a second scan control line electrically connected to the other end of the scan driving circuit.

In some aspects, the plurality of data supply lines respectively transfer a plurality of data voltages output from the data driving circuit to corresponding data lines of the plurality of data lines.

In some aspects, the first scan control line receives a first scan control signal, the second scan control line receives a second scan control signal, and the first scan control signal and the second scan control signal are the same scan control signal.

In some aspects, the display area includes a first display area and a second display area arranged in the second direction from the first display area, the plurality of data lines include a plurality of first data lines arranged in the first display area and a plurality of second data lines arranged in the second display area, and the plurality of first data lines and the plurality of second data lines are electrically isolated from each other.

In some aspects, the plurality of data supply lines include a plurality of first data supply lines electrically connected in one-to-one correspondence with the plurality of first data lines and a plurality of second data supply lines electrically connected in one-to-one correspondence with the plurality of second data lines.

In some aspects, the scan driving circuit includes a first scan driving circuit electrically connected to the first scan control line and a second scan driving circuit electrically connected to the second scan control line, and the first scan driving circuit and the second scan driving circuit are electrically isolated from each other.

In some aspects, the first scan control line receives a first scan control signal, the second scan control line receives a second scan control signal, and the first scan control signal controls the first scan driving circuit, the first scan driving circuit controls operations of the plurality of pixels arranged in the first display area, the second scan control signal controls the second scan driving circuit, and the second scan driving circuit controls operations of the plurality of pixels arranged in the second display area.

In some aspects, the plurality of data lines includes a first row data line and a second row data line, and the plurality of pixels includes a plurality of first row pixels electrically connected to the first row data line, and a plurality of second row pixels electrically connected to the second row data line.

In some aspects, the plurality of data lines includes a first row data line and a second row data line, the plurality of pixels includes a plurality of first pixels electrically connected to the first row data line, and a plurality of second pixels electrically connected to the second row data line, and the plurality of first pixels and the plurality of second pixels are arranged in a same row.

In some aspects, the first scan control line and the second scan control line are electrically connected to the data driving circuit, and receive, from the data driving circuit, a plurality of scan control signals for controlling the scan driving circuit that controls operations of the plurality of pixels.

In some aspects, the electronic device further comprises: a circuit board electrically connected to the display panel, and a control circuit mounted in the circuit board and configured to output a plurality of scan control signals for controlling the scan driving circuit, wherein the scan driving circuit controls operations of the plurality of pixels, and the first scan control line and the second scan control line are electrically connected to the control circuit and receive the plurality of scan control signals from the control circuit.

In some aspects, a width of the display area in the first direction is smaller than a width of the display area in the second direction.

In some aspects, the display panel further comprises an additional circuit arranged in the non-display area in the second direction from the display area.

In some aspects, each pixel of the plurality of pixels includes a pixel circuit and a light-emitting element electrically connected to the pixel circuit, and the plurality of data supply lines are arranged spaced apart in the second directed so as not to overlap with an area in which the pixel circuit is disposed.

In some aspects, an electronic device is provided that comprises: a display panel in which a display area and a non-display area are defined, and a processor that controls an operation of the display panel. The display panel includes a plurality of pixels arranged in the display area, a scan driving circuit arranged in the non-display area, a plurality of scan lines extending from the scan driving circuit in a first direction, the plurality of scan lines being arranged so that each scan line of the plurality of scan lines is spaced apart in a second direction intersecting the first direction, a plurality of data lines extending in the second direction, the plurality of data lines being arranged so that each data line of the plurality of data lines is spaced apart in the first direction, and a plurality of data supply lines extending in parallel with the first direction and electrically connected in one-to-one correspondence with the plurality of data lines, a first scan control line electrically connected to one end of the scan driving circuit, and a second scan control line electrically connected to the other end of the scan driving circuit, the display area including a first display area and a second display area arranged in the second direction from the first display area, and the plurality of data lines including a plurality of first data lines arranged in the first display area and the plurality of second data lines arranged in the second display area.

In some aspects, the plurality of first data lines and the plurality of second data lines are electrically isolated from each other, and the plurality of data supply lines include a plurality of first data supply lines electrically connected in one-to-one correspondence with the plurality of first data lines, and a plurality of second data supply lines electrically connected in one-to-one correspondence with the plurality of second data lines.

In some aspects, the first scan control line receives a first scan control signal, the second scan control line receives a second scan control signal, and the first scan control signal and the second scan control signal are a same scan control signal.

In some aspects, the scan driving circuit includes a first scan driving circuit electrically connected to the first scan control line and a second scan driving circuit electrically connected to the second scan control line, the first scan driving circuit and the second scan driving circuit are electrically isolated from each other, the first scan control line receives a first scan control signal, the second scan control line receives a second scan control signal, the first scan control signal controls the first scan driving circuit, the first scan driving circuit controls operations of the plurality of pixels arranged in the first display area, the second scan control signal controls the second scan driving circuit, and second scan driving circuit controls operations of the plurality of pixels arranged in the second display area.

In some aspects, the plurality of data lines include a first row data line and a second row data line, and the plurality of pixels include a plurality of first row pixels electrically connected to the first row data line, and a plurality of second row pixels electrically connected to the second row data line.

In some aspects, the plurality of data lines include a first row data line and a second row data line, the plurality of pixels include a plurality of first pixels electrically connected to the first row data line, and a plurality of second pixels electrically connected to the second row data line, and the plurality of first pixels and the plurality of second pixels are arranged in the same row.

### BRIEF DESCRIPTION OF THE DRAWINGS

The above and other aspects, features, and advantages of the present disclosure will become more apparent by describing in detail embodiments thereof with reference to the attached drawings, in which:

FIG. 1 is a block diagram of an electronic device according to an embodiment of the present disclosure;

FIG. 2 is a schematic diagram of an electronic device according to various embodiments of the present disclosure;

FIG. 3 is a cross-sectional view of an electronic device according to an embodiment of the present disclosure;

FIG. 4 is a cross-sectional view of a display module according to an embodiment of the present disclosure;

FIG. 5 is a plan view of an electronic device according to an embodiment of the present disclosure;

FIG. 6 is a plan view of an electronic device according to an embodiment of the present disclosure;

FIG. 7 is an equivalent circuit diagram of a pixel according to an embodiment of the present disclosure;

FIG. 8A is a schematic plan view of an electronic device according to an embodiment of the present disclosure;

FIG. 8B is a diagram illustrating a connection relationship between some pixels according to an example embodiment of the present disclosure;

FIG. 9A is a schematic plan view of an electronic device according to an embodiment of the present disclosure;

FIG. 9B is a diagram illustrating a connection relationship between some pixels according to an example embodiment of the present disclosure;

FIG. 10 is a schematic plan view of an electronic device according to an embodiment of the present disclosure; and

FIG. 11 is a schematic plan view of an electronic device according to an embodiment of the present disclosure.

### DETAILED DESCRIPTION

While specific embodiments are illustrated in the drawings and described in detail herein below, the present disclosure may be modified in a variety of ways and realized in many different forms. Accordingly, it will be appreciated that the present disclosure is not limited to the specific disclosed forms, and should be construed to include all modifications, equivalents, or replacements included within the spirit and scope of the present disclosure.

It is to be understood that when a component (or area, layer, portion, etc.) is referred to as being “on” “connected” or “coupled to” another component, it may be directly disposed on, connected to, or coupled to the other component, or a third component may be disposed therebetween.

Hereinafter, embodiments of the disclosure will be described with reference to the attached drawings. When describing with reference to the drawings, identical or corresponding like components are given the same drawing reference numerals and redundant descriptions are thereof are omitted. In addition, in the drawings, thickness, ratios, and dimensions of the components are exaggerated for convenience of explanation, and thus the present disclosure is not necessarily limited to what is shown. The term “and/or” includes all of one or more combinations that the associated components may define.

It is to be understood that, although the terms “first”, “second”, etc. may be used to describe various components, but the components are not be limited by these terms. These terms are used only for the purpose of distinguishing one component, part, area, layer or portion from another component, part, area, layer or portion. For example, a first component, a first part, a first area, a first layer, or a first portion may be termed a second component, a second part, a second area, a second layer, or a second portion, and similarly a second component, second part, second area, second layer, or second portion may also be termed a first component, first part, first area, first layer, or first portion without departing from the scope of the present disclosure. The singular expressions “a”, “an” and “the” include the plural expressions, unless the context clearly indicates otherwise.

In addition, the terms “below”, “beneath”, “above”, “on top”, “lower”, “upper” and the like, are used herein for ease of description to describe one element or feature’s relationship to another element or feature, as shown in the drawings. These terms are described in relative terms, with reference to the directions indicated in the drawings.

It will be understood that the terms “include/comprise/have” or “including/comprising/having” and the like is intended to designate the presence of features, numbers, steps, operations, components, parts, or combinations thereof described in the specification, and do not preclude the presence or possibility of addition of one or more other features or numbers, steps, operations, components, parts, or combinations thereof.

In the present disclosure, “A and/or B” refers to either A, B, or both A and B, and, “at least one of A and B” indicates the case where it is A, or B, or both A and B.

The x-axis, y-axis, and z-axis are not limited to the three axes on the orthogonal coordinate system, and may be interpreted in a broad sense that includes them. For example, the x-axis, y-axis, and z-axis may be orthogonal to each other, but they may also refer to different directions that are not orthogonal to each other.

In some aspects, an electronic device of the present disclosure may further include a module or device having additional functions in addition to the display function.

In addition, the terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art.

Unless defined otherwise, all terms (including technical and scientific terms) used herein have the same meaning as commonly understood by one of ordinary skill in the art to which this disclosure belongs. In addition, terms such as those defined in commonly used dictionaries should be interpreted as having a meaning that is consistent with their meaning they have in the context of the relevant art, and should not be interpreted in an idealized or overly formal sense unless explicitly defined herein.

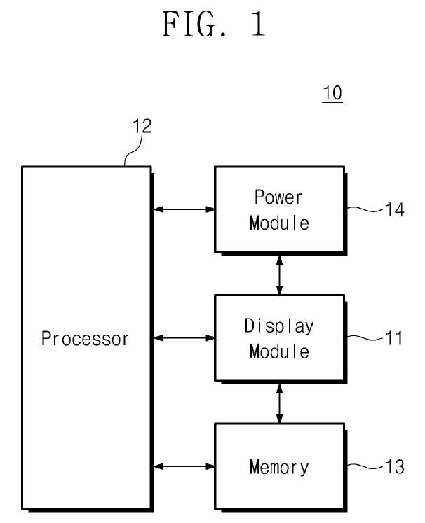

FIG. 1 is a block diagram of an electronic device 10 according to an embodiment of the present disclosure.

Referring to FIG. 1, the electronic device 10 according to an embodiment may include a display module 11, a processor 12, a memory 13, and a power supply module 14.

The display module 11 may display an image. The image may include a still image as well as a moving image. The processor 12 may include at least one of a central processing unit (CPU), an application processor (AP), a graphic processing unit (GPU), a communication processor (CP), an image signal processor (ISP), and a controller. The processor 12 may be configured to control an operation of the display module 11.

The memory 13 may store data information necessary for operations of the processor 12 or the display module 11. When the processor 12 executes an application stored in the memory 13, an image data signal and/or an input control signal are transferred to the display module 11, and the display module 11 may process the received signal to output image information through a display panel.

The power supply module 14 may include a power supply module such as a power adapter, a battery device, etc., and a power conversion module that converts power supplied by the power supply module to generate power required for an operation of the electronic device 10.

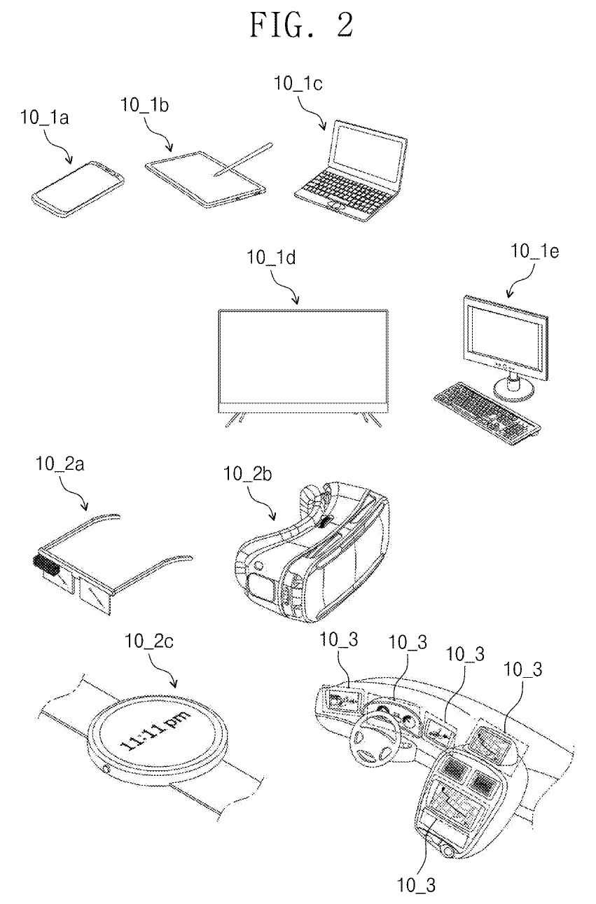

FIG. 2 is a schematic diagram of an electronic device according to various embodiments of the present disclosure.

Referring to FIG. 2, various electronic devices to which a display device according to embodiments is applied may include an electronic device for displaying an image such as a smartphone 10_1a, a tablet PC 10_1b, a laptop 10_1c, a TV 10_1d, and a desk monitor 10_1e, as well as a wearable electronic device including a display module such as smart glasses 10_2a, a head mounted display 10_2b, a smart watch 10_2c, and the like, an electronic device for a vehicle 10_3 including a display module, such as a Center Information Display (CID) disposed on an instrument panel, a center fascia, and a dashboard of a vehicle, a room mirror display, and the like.

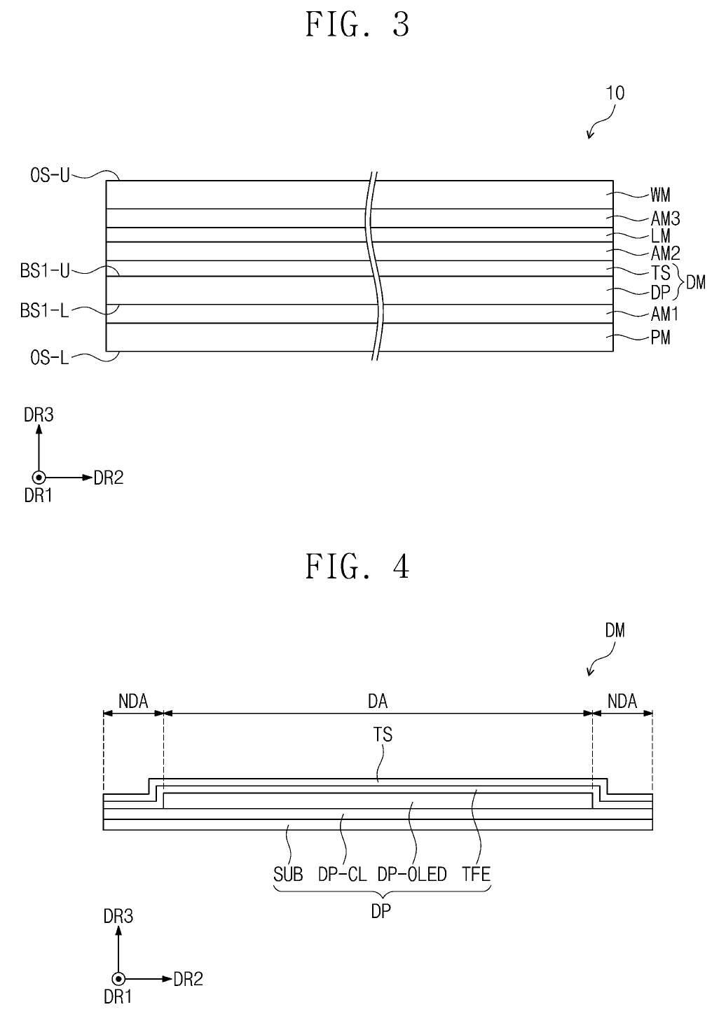

FIG. 3 is a cross-sectional view of an electronic device 10 according to an embodiment of the present disclosure. FIG. 3 shows a cross section defined by a second direction DR2 and a third direction DR3.

Referring to FIG. 3, the electronic device 10 may include a protective film PM, a display module DM, an optical member LM, a window WM, a first adhesive member AM1, a second adhesive member AM2, and a third adhesive member AM3. Components included in the electronic device 10 are not limited to the above-described components. At least some of the above-described components may be omitted, and other components may be added.

The display module DM may be disposed between the protective film PM and the optical member LM. The optical member LM may be disposed between the display module DM and the window WM. The first adhesive member AM1 may be configured to couple the display module DM and the protective film PM, the second adhesive member AM2 may be configured to couple the display module DM with the optical member LM, and the third adhesive member AM3 may be configured to couple the optical member LP with the window WM.

The protective film PM may protect the display module DM. The protective film PM may provide a first outer surface OS-L exposed to an outside and provide an adhesive surface adhered to the first adhesive member AM1. The protective film PM may prevent external moisture from penetrating into the display module DM and absorb an external impact.

The protective film PM may include a plastic film as a base substrate. The protective film PM may include a plastic film including any one selected from the group consisting of polyethersulfone (PES), polyacrylate, polyetherimide (PEI), polyethylenenaphthalate (PEN), polyethyleneterephthalate (PET), polyphenylene sulfide (PPS), polyarylate, polyimide (PI), polycarbonate (PC), polyarylene ethersulfone, and combinations thereof.

The material constituting the protective film PM is not limited to plastic resins, and may include an organic/inorganic composite material. The protective film PM may include a porous organic layer and an inorganic material filled in pores of the organic layer. The protective film PM may further include a functional layer formed on the plastic film. The functional layer may include a resin layer. The functional layer may be formed by a coating method. In an embodiment of the present disclosure, the protective film PM may be omitted.

The window WM may protect the display module DM from the external impact and provide an input surface to a user. The window WM may provide a second outer surface OS-U exposed to the outside and provide an adhesive surface adhered to the second adhesive member AM2.

The window WM may include a plastic film. The window WM may have a multilayer structure. The window WM may have a multilayer structure selected from a glass substrate, a plastic film, and a plastic substrate. The window WM may further include a bezel pattern. The multilayer structure may be formed through a continuous process or an adhesion process using an adhesion layer.

The optical member LM may reduce an external light reflectance. The optical member LM may include a polarizing film. The optical member LM may further include a retardation film. In an embodiment of the present disclosure, the optical member LM may be omitted.

The display module DM may include a display panel DP and a touch sensing unit TS. The touch sensing unit TS may be directly disposed on the display panel DP. “Directly disposed” herein may mean formed by a continuous process, with an exception of attaching using a separate adhesive layer. However, this is illustrative and the touch sensing unit TS may be formed over a film or a substrate and then disposed over a thin film encapsulation layer TFE (see FIG. 4). In an embodiment, the touch sensing unit TS may be omitted.

The display panel DP may generate an image corresponding to an input image data. The display panel DP may provide a first display panel surface BS1-L and a second display panel surface BSS1-U facing each other in the third direction DR3.

The touch sensing unit TS may obtain coordinate information of an external input. The touch sensing unit TS may sense the external input in a capacitive manner.

Although not shown separately, the display module DM according to an embodiment of the present disclosure may further include an anti-reflection layer. The anti-reflection layer may include a color filter or stacked structures of conductive layer/insulating layer/conductive layer. The anti-reflective layer may absorb or destructively interfere with or polarize light incident from the outside to reduce the external light reflectance. The anti-reflection layer may replace the function of the optical member LM.

Each of the first adhesive member AM1, the second adhesive member AM2, and the third adhesive member AM3 may be an organic adhesive layer such as an optically clear adhesive film (OCA), an optically clear resin (OCR), or a pressure sensitive adhesive film (PSA). The organic adhesive layer may include an adhesive material such as polyurethane-based, polyacrylic-based, polyester-based, polyepoxy-based, or polyvinyl acetate-based. In an embodiment, at least one of the first adhesive member AM1, the second adhesive member AM2, and the third adhesive member AM3 may be omitted.

FIG. 4 is a cross-sectional view of a display module DM according to an embodiment of the present disclosure.

Referring to FIG. 4, the display module DM may include a display panel DP and a touch sensing unit TS. In FIG. 4, an organic light-emitting display panel is typically described as an example of the display panel DP. However, the present disclosure is not limited thereto, and the display panel DP may be a liquid crystal display panel, a plasma display panel, or an electrophoretic display panel.

The display panel DP may include a base layer SUB, a circuit layer DP-CL disposed on the base layer SUB, a light-emitting element layer DP-OLED, and a thin film encapsulation layer TFE.

The base layer SUB may include at least one plastic film. The base layer SUB may include a transparent flexible substrate, a plastic substrate, a glass substrate, a metal substrate, an organic/inorganic composite substrate, and the like. The plastic substrate may include at least one of an acrylic resin, a methacrylic resin, polyisoprene, a vinyl resin, an epoxy resin, a urethane resin, a cellulose resin, a siloxane resin, a polyimide resin, a polyamide resin, and a perylene resin. The “transparent” is meant having a light transmission of greater than 0%, including translucent.

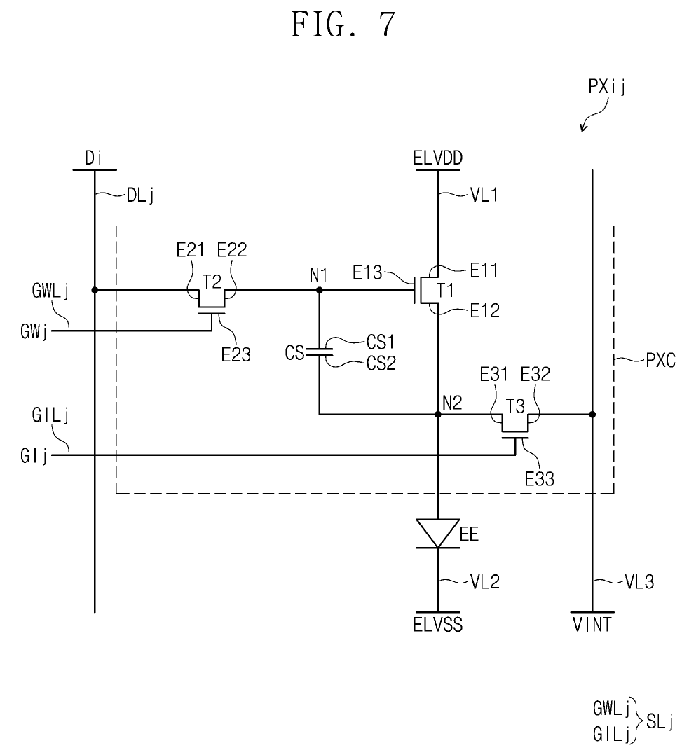

The circuit layer DP-CL may include a plurality of insulating layers, a plurality of conductive layers, and a semiconductor layer. The plurality of conductive layers of the circuit layer DP-CL may constitute a control circuit of signal lines or pixels. The circuit layer DP-CL may include a pixel circuit PXC of FIG. 7 (see FIG. 7), and the control circuit of the pixel may correspond to the pixel circuit PXC (see FIG. 7).

The light-emitting element layer DP-OLED may include organic light-emitting diodes. The light-emitting element layer DP-OLED may include a light-emitting element EE of FIG. 7 (see FIG. 7).

The thin film encapsulation layer TFE may seal the light-emitting device layer DP-OLED. The thin film encapsulation layer TFE may include a plurality of inorganic thin films and at least one organic thin film. The at least one organic thin film may be disposed between the plurality of inorganic thin films. The inorganic thin films may protect the light-emitting element layer DP-OLED from moisture/oxygen, and the organic thin films may protect a light-emitting element layer DP-OLED from foreign matter such as dust particles.

The touch sensing unit TS may include touch sensors and touch signal lines. The touch sensors and the touch signal lines may have a single-layer or multi-layer structure. The touch sensors and the touch signal lines may include indium tin oxide (ITO), indium zinc oxide (IZO), zinc oxide (ZnO), indium tin zinc oxide (ITZO), PEDOT, metal nanowires, and graphene. The touch sensors and the touch signal lines may include a metal layer, such as molybdenum, silver, titanium, copper, aluminum, or an alloy thereof. The touch sensors and the touch signal lines may have the same layer structure, or may have different layer structures.

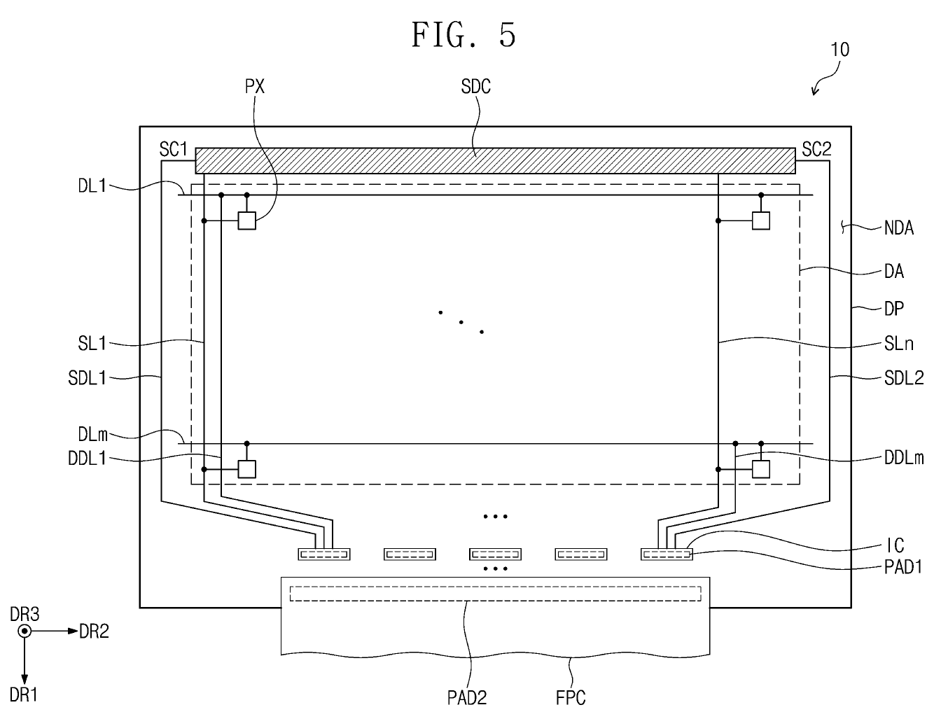

FIG. 5 is a plan view of an electronic device 10 according to an embodiment of the present disclosure.

Referring to FIG. 5, the electronic device 10 may include a display panel DP, a plurality of driving chips IC, and a printed circuit board FPC.

A display area DA and a non-display area NDA adjacent to the display area DA may be defined in the display panel DP. In an embodiment of the present disclosure, a width of the display area DA in a first direction DR1 may be smaller than a width of the display area DA in the second direction DR2. In an embodiment, the non-display area NDA may be defined along an edge of the display area DA. The example embodiment of FIG. 5 illustrates a case where the display area DA has a rectangular shape, but is not limited thereto. The display area DA may have a circular shape, a polygonal shape, and the like, and may be changed according to the structure/design of the display panel DP.

The display panel DP may include a plurality of pixels PX, a scan driving circuit SDC, a plurality of scan lines SL1 to SLn, a first pad unit PAD1, a plurality of data lines DL1 to DLm, a plurality of data supply lines DDL1 to DDLm, a first scan control line SDL1, a second scan control line SDL2, and a second pad unit PAD2. For the present example, “n” may be an integer having a value of two or more, and “m” may be an integer having a value of two or more. The operation of the display panel DP may be controlled by the processor 12 (see e.g., FIG. 1).

The pixels PX may be arranged in the display area DA. The pixels PX may be arranged in the first direction DR1 and the second direction DR2. Each of the pixels PX includes the light-emitting element EE (see FIG. 7) and the pixel circuit PXC (see FIG. 7) that controls light-emission of the light-emitting element EE (see FIG. 7). The pixel circuit PXC (see FIG. 7) may include one or more transistors and one or more capacitors.

The scan driving circuit SDC may be arranged in the non-display area NDA. However, the present disclosure is not limited thereto, and at least a portion of the scan driving circuit SDC may be arranged to overlap the display area DA. The scan driving circuit SDC may output scan signals to the scan lines SL1 to SLn in response to a plurality of scan control signals SC1 and SC2. The scan driving circuit SDC may include transistors formed through the same process as the pixel circuit PXC (see FIG. 7).

The scan lines SL1 to SLn may extend from the scan driving circuit SDC in the first direction DR1 and may be arranged in the second direction DR2 intersecting the first direction DR1. The scan lines SL1-SLn may be electrically connected to corresponding pixels among the pixels PX. For example, the first scan line SL1 may be electrically connected to the pixels PX arranged in the first column, and the n-th scan line SLn may be electrically connected to the pixels PX arranged in the n-th column.

The first pad unit PAD1 may be disposed in the non-display area NDA of the display panel DP. The first pad unit PAD1 may be electrically connected to the data lines DL1 to DLm.

In an embodiment of the present disclosure, each of the driving chips IC may be electrically connected to the first pad unit PAD1 of the display panel DP. The example embodiment of FIG. 5 illustrates a case where each of the driving chips IC is mounted on the display panel DP in a chip-on-plastic (COP) manner or a chip-in-glass (COG) manner. However, the present disclosure is not limited thereto, and each of the driving chips ICs may be mounted on a separate circuit film electrically connected to the display panel DP in a chip-on-film (COF) manner to be electrically connected to the display panel DP. In addition, each of the driving chips IC may be electrically connected to the first pad unit PAD1 through an anisotropic conductive film ACF, or may be electrically connected by a soldering method.

Each of the driving chips IC may include a data driving circuit that outputs a plurality of data voltages corresponding to the pixels PX. In an embodiment of the present disclosure, the number of the driving chips IC may be five. The data driving circuit in one driving chip IC may output data voltages to 2160 channels, for example, 2160 data lines DL1 to DLm. That is, the data driving circuit of the electronic device 10 illustrated in FIG. 5 may output data voltages to 2160x5 data lines DL1 to DLm. However, the present disclosure is not limited thereto, and the number of the driving chips IC may be variously changed. Hereinafter, the data driving circuit will be described with reference to the same reference numerals as those of the driving chips IC. The data driving circuit IC may include transistors formed through the same process as the pixel circuit PXC (see FIG. 7).

Operations of the data driving circuit IC may be controlled by the processor 12 (see FIG. 1). For example, the data driving circuit IC may receive a data control signal and an output image signal from the processor 12 (see FIG. 1). The data driving circuit IC may convert the output image signal into data voltages (or data signals) and output the data voltages to the data lines DL1 to DLm. Each of the data voltages may have a voltage level corresponding to a gray level of the output image signal. Accordingly, the data driving circuit IC may output corresponding data voltages to each of the data lines DL1 to DLm.

In an embodiment of the present disclosure, the data driving circuit IC may be arranged on the non-display area NDA on the lower side of the display panel DP. The data driving circuit IC may be spaced apart from the scan driving circuit SDC in the first direction DR1. In this case, the display area DA may be arranged between the data driving circuit IC and the scan driving circuit SDC.

The data lines DL1 to DLm extend in the second direction DR2 and may be arranged in the first direction DR1. The data lines DL1 to DLm may be electrically connected to corresponding pixels among the pixels PX.

The data supply lines DDL1 to DDLm extend parallel to the first direction DR1 from the data driving circuit IC, and may be electrically connected to the data lines DL1 to DLm in a one-to-one correspondence. The data supply lines DDL1 to DDLm may transfer data voltages output from the data driving circuit IC to the corresponding data lines DL1 to DLm, respectively.

In an embodiment, the data supply lines DDL1 to DDLm may be electrically connected to the data lines DL1 to DLm in the display area DA. However, the present disclosure is not limited thereto, and the data supply lines DDL1 to DDLm may be electrically connected to the data lines DL1 to DLm in the non-display area NDA.

One end of the first scan control line SDL1 may be electrically connected to the data driving circuit IC, and the other end of the first scan control line SDL2 may be electrically connected to one end of the scan driving circuit SDC. One end of the second scan control line SDL2 may be electrically connected to the data driving circuit IC, and the other end of the second scan control line SDL2 may be electrically connected to the other end of the scan driving circuit SDC.

In an embodiment of the present disclosure, the first scan control line SDL1 may receive a first scan control signal SC1 from the data driving circuit IC, and the second scan control line SDL2 may receive a second scan control signal SC2 from the data driving circuit IC. The first scan control signal SC1 and the second scan control signal SC2 may be signals for controlling the scan driving circuit SDC that controls operations of the pixels PX. In an embodiment, the first scan control signal SC1 and the second scan control signal SC2 may be the same signal. That is, since the scan driving circuit SDC may receive the same scan control signals in both directions, the scan control signals may be supplied without delay.

Although the example embodiment of FIG. 5 illustrates a case where each of the first scan control line SDL1 and the second scan control line SDL2 is connected to the first pad unit PAD1 arranged in the non-display area NDA of the display panel DP, the example embodiment is not limited thereto, and a connection relationship between the scan control lines SDL1 and SDL2 may be variously changed. In addition, although the first scan control line SDL1 and the second scan control line SDL2 are illustrated one by one in FIG. 5, the number of the scan control lines SDL1 and SDL2 may be variously changed.

According to the present disclosure, the data driving circuit IC and the scan driving circuit SDC may be arranged above or below the display panel DP. Accordingly, widths of the non-display areas NDA on the left and right sides of the display panel DP may decrease.

The printed circuit board FPC may be electrically coupled to the second pad unit PAD2. That is, the printed circuit board FPC may be electrically connected to the display panel DP. The printed circuit board (FPC) may have flexible properties. After being coupled to the display panel DP, the printed circuit board FPC may be bent to the rear surface of the display panel DP. The printed circuit board FPC may transfer a control signal and the like for controlling driving of the display panel DP. The printed circuit board FPC and the second pad unit PAD2 may be electrically connected to each other through an anisotropic conductive film ACF. The printed circuit board FPC may be referred to as a circuit board FPC.

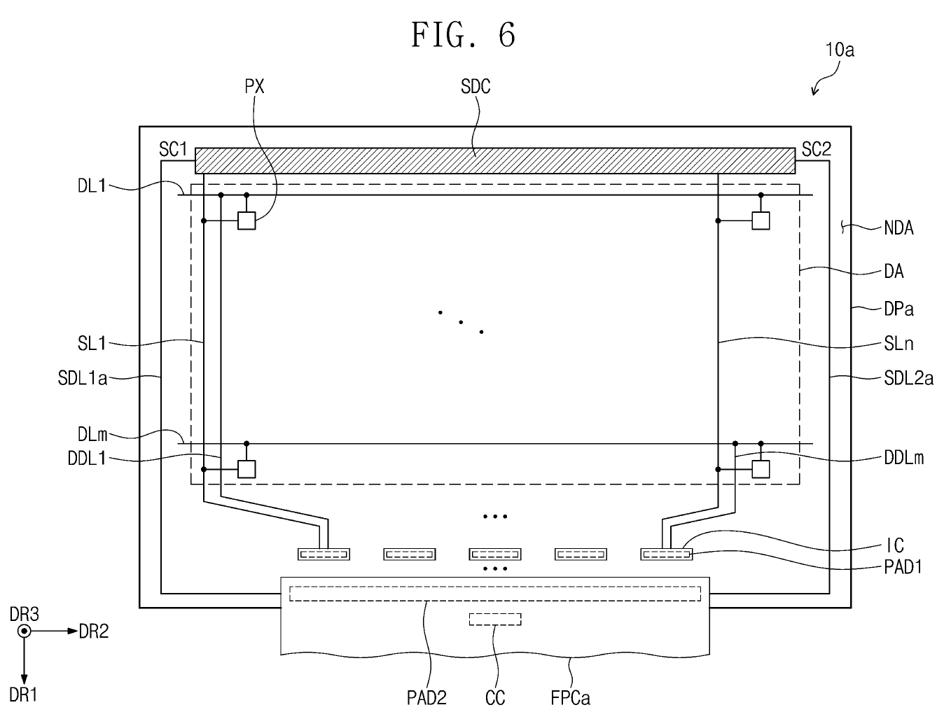

FIG. 6 is a plan view of an electronic device 10a according to an embodiment of the present disclosure. In FIG. 6, the same components as those in FIG. 5 are denoted by the same reference numerals, and the description thereof is omitted. In FIG. 6, differences from FIG. 5 will be mainly described.

Referring to FIG. 6, the electronic device 10a may include a display panel DPa, a circuit board FPCa, and a control circuit CC.

In an embodiment of the present disclosure, the control circuit CC may be mounted in the circuit board FPCa. The control circuit CC in the circuit board FPCa may be electrically connected to the display panel DPa through the second pad unit PAD2.

A first scan control line SDL1a and a second scan line SDL2a may be electrically connected to the control circuit CC. The control circuit CC may output scan control signals SC1 and SC2 that control the scan driving circuit SDC that controls operations of the pixels PX. The first scan control line SDL1a and the second scan control line SDL2a may receive the scan control signals SC1 and SC2, respectively, from the control circuit CC.

For example, one end of the first scan control line SDL1a may be electrically connected to the control circuit CC, and the other end of the first scan control line SDL1a may be electrically connected to one end of the scan driving circuit SDC. One end of the second scan control line SDL2a may be electrically connected to the control circuit CC, and the other end of the second scan control line SDL1a may be electrically connected to the other end of the scan driving circuit SDC.

In an embodiment of the present disclosure, the first scan control line SDL1a may receive the first scan control signal SC1 from the control circuit CC, and the second scan control line SDL2a may receive the second scan control signal SC2 from the control circuit CC. In an embodiment, the first scan control signal SC1 and the second scan control signal SC2 may be the same signal. That is, since the scan driving circuit SDC may receive the same scan control signals in both directions, the scan control signals may be supplied without delay.

Although the example embodiment of FIG. 6 illustrates a case where each of the first scan control line SDL1a and the second scan control line SDL2a is connected to the second pad unit PAD2 arranged in the non-display area NDA of the display panel DPa, the example embodiment is not limited thereto, and a connection relationship between the scan control lines SDL1a and SDL2a may be variously changed.

FIG. 7 is an equivalent circuit diagram of a pixel PXij according to an embodiment of the present disclosure.

Referring to FIGS. 5 and 7, an example equivalent circuit diagram of the pixel PXij connected to the itch data line DLi among the data lines DL1 to DLm and the j-th scan line SLj among the scan lines SL1 to SLn is shown. Each of the pixels PX illustrated in FIG. 5 may have the same circuit configuration as the example equivalent circuit diagram of the pixel PXij illustrated in FIG. 7.

In an embodiment, each of the scan lines SL1 to SLn may include two scan lines. For example, the j-th scan line SLj may include a j-th write scan line GWLj and a j-th initialization scan line GILj. Hereinafter, the i-th data line DLi is referred to as a data line DLi, and the j-th write scan line GWLj and the j-th initialization scan line GILj are referred to as a write scan line GWLj and an initialization scan line GILj, respectively.

The pixel circuit PXC may include first to third transistors T1, T2, and T3 and a capacitor CS. The pixel PXij illustrated in FIG. 7 is merely an example, and a circuit configuration of the pixel PXij may be changed and implemented.

Each of the first to third transistors T1, T2, and T3 may be an N-type transistor having an oxide semiconductor layer. The first transistor T1 may be referred to as a driving transistor, the second transistor T2 may be referred to as a switching transistor, and the third transistor T3 may be referred to as an initialization transistor.

The write scan line GWLj and the initialization scan line GILj may transfer first and second scan signals GWj and GIj, respectively. The data line DLi may transfer a data voltage Di.

The first to third driving voltage lines VL1, VL2, and VL3 may transfer the first driving voltage ELVDD, the second driving voltage ELVSS, and the initialization voltage VINT to the pixel PXij, respectively.

The first transistor T1 may include a first electrode E11 electrically connected to the first driving voltage line VL1, a second electrode E12 electrically connected to an anode of the light-emitting element EE, and a gate electrode E13 electrically connected to a first node N1. A portion where the second electrode E12 of the first transistor T1 is connected to the light-emitting element EE may be defined as a second node N2.

The second transistor T2 may include a first electrode E21 connected to the data line DLi, a second electrode E22 connected to the first node N1, and a gate electrode E23 connected to the write scan line GWLj. The second transistor T2 may transfer the data voltage Di received through the data line DLi to the first node N1 in response to the first scan signal GWj received through the write scan line GWLj.

The capacitor CS may be connected between the first node N1 and the second node N2. The first counter electrode CS1 of the capacitor CS may be connected to the first node N1, and the second counter electrode CS2 of the capacitor CS may be connected to the second node N2.

The third transistor T3 may include a first electrode E31 connected to the second node N2, a second electrode E32 connected to the third driving voltage line VL3, and a gate electrode E33 connected to the initialization scan line GILj. The third transistor T3 may transfer the initialization voltage VINT received through the third driving voltage line VL3 to the second node N2 in response to the second scan signal GIj received through the initialization scan line GILj.

The light-emitting element EE may include an anode connected to the second electrode E12 of the first transistor T1 and the second node N2 and a cathode connected to the second driving voltage line VL2. The light-emitting element EE may be an organic light-emitting diode including an organic light-emitting layer, but is not particularly limited thereto.

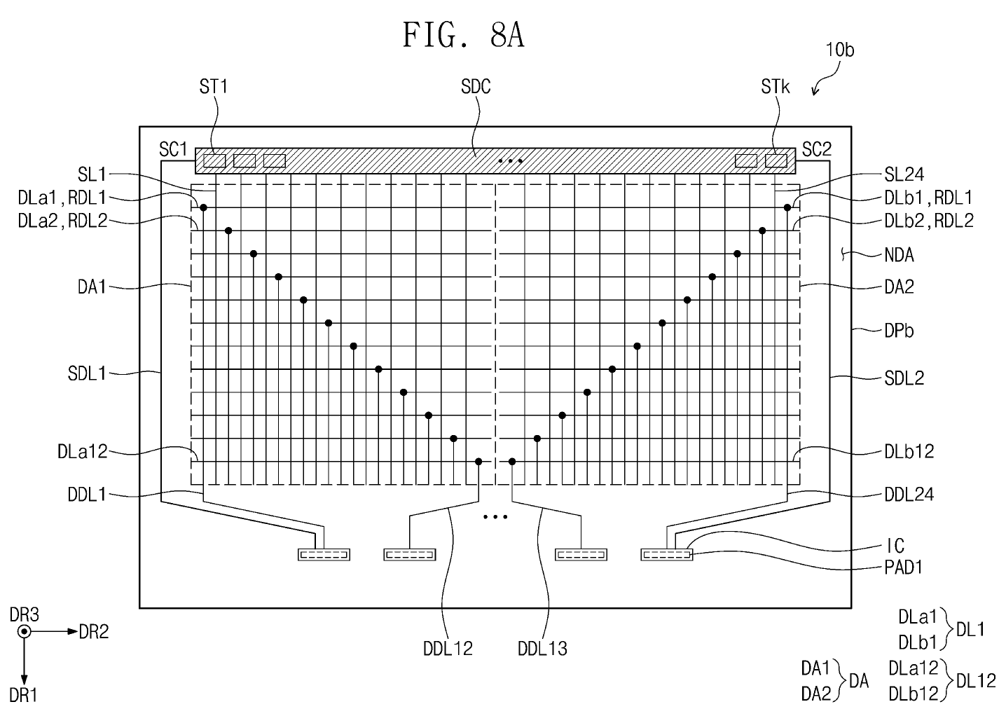

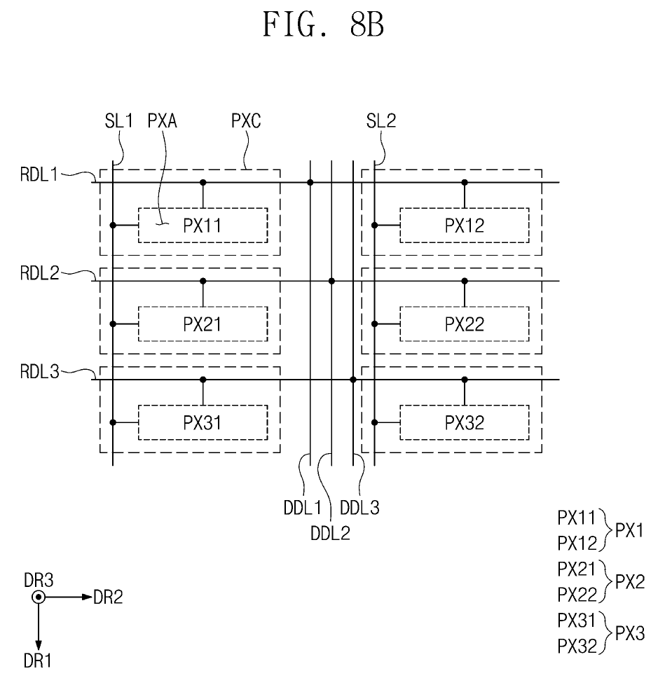

FIG. 8A is a schematic plan view of an electronic device 10b according to an embodiment of the present disclosure. The example embodiment of FIG. 8A illustrates a case where the display panel DPb includes 24 scan lines SL1 to SL24, 12 data lines DL1 to DL12, and 24 data supply lines DDL1 to DDL24.

Referring to FIGS. 5 and 8A, the display area DA may include a first display area DA1 and a second display area DA2 arranged from the first display area DA2 in the second direction DR2.

In an embodiment of the present disclosure, the data lines DL1 to DL12 may include a plurality of first data lines DLa1 to DLa12 arranged in the first display area DA1 and a plurality of second data lines DLb1 to DLb12 arranged in the second display area DA2. For example, a first first data line DLa1 and a first second data line DLb2 may be the data lines DL1 of the first row, and a last first data line DLa12 and a last second data line DLb12 may be the data line DL12 of the last row.

In an embodiment of the present disclosure, the first data lines DLa1 to DLa12 and the second data lines DLb1 to DLb12 may be electrically isolated from each other.

The data lines DL1 to DL12 may be electrically connected to corresponding pixels among the pixels PX. In an embodiment, the first data lines DLa1 to DLa12 may be electrically connected to corresponding pixels among the pixels PX arranged in the first display area DA1, and the second data lines DLb1 to DLb12 may be electrically connect to corresponding pixels among the pixels arranged in the second display area DA2.

For example, the first data line DLa1 among the first data lines DLa1 to DLa12 may be arranged in the first display area DA1 and electrically connected to the pixels PX arranged in the first row. The last first data line DLa12 among the first data lines DLa1 to DLa12 may be arranged in the first display area DA1 and electrically connected to the pixels PX arranged in the last row. In addition, the first second data line DLb1 among the second data lines DLb1 to DLb12 may be arranged in the second display area DA2 and electrically connected to the pixels PX arranged in the first row. The last second data line DLb12 among the second data lines DLb1 to DLb12 may be arranged in the second display area DA2 and electrically connected to the pixels PX arranged in the last row.

In an embodiment of the present disclosure, each of the first data lines DLa1 to DLa12 and the second data lines DLb1 to DLb12 may include a first row data line RDL1 and a second row data line RDL2. For example, each of the first first data line DLa1 among the first data lines DLa1 to DLa12 and the first second data line DLb1 among the second data lines DLb1 to DLb12 may be referred to as the first row data line RDL1. In addition, each of the second first data line DLa2 among the first data lines DLa1 to DLa12 and the second data line DLb2 arranged in the second row among the second data lines DLb1 to DLb12 may be referred to as the second row data line RDL2. Hereinafter, the first row data line RDL1 (for example, DLa1) and the second row data line RDL2 (for example, DLa2) among the first data lines DLa1 to DLa12 will be described as examples, and the same description applies to the second data lines DLb1 to DLb12.

In an embodiment of the present disclosure, the data supply lines DDL1 to DDL24 may include a plurality of first data supply lines DDR1 to DDL12 and a plurality of second data supply lines DDD13 to DDL24. The first data supply lines DDL1 to DDL12 may be electrically connected to the first data lines DLa1 to DLa12 arranged in the first display area DA1 in a one-to-one correspondence, and the second data supply lines DLD13 to DDL24 may be electrically connected to the second data lines DLb1 to DLb12 arranged in the second display area DA2 in a one-to-one correspondence.

In an embodiment of the present disclosure, the first data supply lines DDL1 to DDL12 may be arranged in the second direction DR2. The first data supply lines DDL1 to DDL12 may be sequentially shortened in length in the second direction DR2. For example, a first first data supply line DDL1 among the first data supply lines DDL1 to DDL12 may be electrically connected to the first data line DLa1 arranged at the top of the display panel DPb, and a last first data supply line DDL12 among the first data supply lines DDL1 to DDL12 may be electrically connected to the last first data line DLa12 arranged at the bottom of the display panel DPb.

The second data supply lines DDL13 to DDL24 may be arranged in the second direction DR2. The second data supply lines DDL13 to DDL24 may be sequentially lengthened in the second direction DR2. For example, a first second data supply line DDL13 among the second data supply lines DDL13 to DDL24 may be electrically connected to a last second data line DLb12 arranged at the bottom of the display panel DPb, and last second data supply line DDL24 among the second data supply lines DDL13 to DDL24 may be electrically connected to the first second data line DLb1 arranged at the top of the display panel DPb.

In an embodiment of the present disclosure, the scan driving circuit SDC may include a plurality of stages ST1 to STk. The stages ST1 to STk may be electrically connected to the scan lines SL1 to SL24, respectively. The stages ST1 to STk may be sequentially driven from the first stage ST1 to the k-th stage STk. In one embodiment, the number of the stages ST1 to STk may be equal to or greater than the number of the scan lines SL1 to SL24. However, the present disclosure is not limited thereto, and one stage may be connected to a plurality of scan lines.

According to the present disclosure, since the first data lines DLa1 to DLa12 and the second data lines DLb1 to DLb12 are electrically isolated from each other, the first display area DA1 and the second display area DA2 may be used as a full screen or a split (or divided) screen.

Since operations of the pixels PX included in each of the first display area DA1 and the second display area DA2 are controlled by one integrated scan driving circuit SDC, the first display area DA1 and the second display area DA2 may be used as a full screen. In addition, since the pixels PX included in each of the first display area DA1 and the second display area DA2 may receive different data voltages through each of the first data lines DLa1 to DLa12 and the second data lines DLb1 to DLb12 that are electrically isolated from each other, the first display area DA1 and the second display area DA2 may also be used as a split screen.

For example, four driving chips IC may be mounted on the display panel DPb. When only the first display area DA1 of the display panel DPb is driven, only some driving chips IC that output data voltages to the first display area DA1 among the driving chips IC are activated, and the remaining driving chips IC may be deactivated. In this case, power consumption of the electronic device 10b may be reduced. However, the present disclosure is not limited thereto, and one driving chip IC may output data voltages to both the first display area DA1 and the second display area DA2. When only the first display area DA1 of the display panel DPb is driven, the one driving chip IC is activated, and some driving chips that output data voltages only in the second display area DA2 may be deactivated.

FIG. 8B is a diagram illustrating a connection relationship between some pixels PX according to an example embodiment of the present disclosure. In FIG. 8B, six pixels PX11, PX12, PX21, PX22, PX31, and PX32 are illustrated as an example.

Referring to FIGS. 5, 8A, and 8B, the pixels PX may include first to sixth pixels PX11, PX12, PX21, PX22, PX31, and PX32. The first pixel PX11 may be electrically connected to the first row data line RDL1 and the first column scan line SL1, the second pixel PX12 may be electrically connected to the first row data lines RDL1 and second column scan line SL2, the third pixel PX21 may be electrically connected to the second row data line RDL2 and the first column scan line SL1, the fourth pixel PX22 may be electrically connected to the second row data line RDL2 and the second column scan line SL2, the fifth pixel PX31 may be electrically connected to the third row data line RDL3 and the first column scan line SL1, and the sixth pixel PX32 may be electrically connected to the third row data line RDL3 and the second column scan line SL2.

In an embodiment of the present disclosure, a first first data supply line DDL1 may be electrically connected to the first row data line RDL1, a first second data supply line DDL2 may be electrically connected to the second row data line RDL2, and a first third data supply line DDL3 may be electrically connected to the third row data line RDL3.

In an embodiment of the present disclosure, each of the first row data line RDL1, the second row data line RDL2, and the third row data line RDL3 may be electrically connected to corresponding pixels PX. For example, the first row data line RDL1 may be electrically connected to a plurality of first row pixels PX1 among the pixels PX, and the second row data line RDL2 may be electrically connected to a plurality of second row pixels PX2 among the pixels PX. The first row pixels PX1 may be pixels arranged in a first row of the pixels PX arranged in the first display area DA1, and the second row pixels PX2 may be pixels arranged in a second row of the pixels PX arranged in the first display area DA1.

In an embodiment of the present disclosure, the first row pixels PX1, the second row pixels PX2, and the third row pixels PX3 may be pixels that emit light different from each other. For example, each of the first row pixels PX1 may be a red pixel, each of the second row pixels PX2 may be a green pixel, and each of the third row pixels PX3 may be a blue pixel. However, the present disclosure is not limited thereto, and an arrangement relationship of the pixels PX may be variously changed. In addition, in an embodiment, each of the pixels PX may be a pixel of various colors such as yellow, cyan, magenta, white, and the like.

In an embodiment of the present disclosure, each of the pixels PX11, PX12, PX21, PX22, PX31, and PX32 may include a pixel circuit PXC and a light-emitting element EE (see FIG. 7) electrically connected to the pixel circuit PXC. A light-emitting area PXA may be defined in the light-emitting element EE. In an embodiment, a width of the light-emitting area PXA in the first direction DR1 may be smaller than a width in the second direction DR2.

The first first to first third data supply lines DDL1, DDL2, and DDL3 may be arranged not to overlap with an area in which the pixel circuit PXC is disposed, as shown in FIG. 8B. However, the present disclosure is not limited thereto, and at least some of the first first to first third data supply lines DDL1, DDL2, and DDL3 may be arranged to overlap an area in which the pixel circuit PXC is disposed.

According to the present disclosure, since the first data lines DLa1 to DLa12 and the second data lines DLb1 to DLb12 are electrically connected to the first data supply lines DDL1 to DDL12 and the second data supply lines DDL13 to DDL24 in a one-to-one correspondence, respectively, the first display area DA1 and the second display area DA2 may be used as a full screen or a split screen.

In addition, according to the present disclosure, the first data lines DLa1 to DLa12 and the second data lines DLb1 to DLb12 may be electrically isolated from each other. The data lines extending in the relatively wide second direction DR2 may be divided into two data line groups and electrically connected to different data supply lines, respectively. In this case, a length of each of the first data lines DLa1 to DLa12 and the second data lines DLb1 to DLb12 may be smaller than a width of the second direction DR2 of the display area DA. For example, a length of each of the first data lines DLa1 to DLa12 and the second data lines DLb1 to DLb12 may be half the width of the second direction DR2 of the display area DA. As the length of each of the first data lines DLa1 to DLa12 and the second data lines DLb1 to DLb12 is shortened, signal loss transferred through the first data lines DLa1 to DLa12, and the second data lines DLb1 to DLb12 may be reduced.

In addition, when the number of the entire data lines DL1 to DL12 arranged in the first direction DR1 decreases, the number of pixels PX electrically connected to one data line increases, so that the time for charging the data voltage to the pixels PX when driving at a high frequency may be insufficient. However, according to the present disclosure, since the data lines are divided into two data line groups and electrically connected to different data supply lines, the time for charging the data voltage to the pixels PX may be ensured even when driving at a high frequency.

In addition, according to the present disclosure, since the number of the entire data lines DL1 to DL12 arranged in the first direction DR1 decreases, interference between the data lines DL1 to DL12 and the pixel circuit PXC (see FIG. 7) of each of the pixels PX may be reduced. For example, interference between the data lines DL1 to DL12 and the driving transistor T1 of each of the pixels PX (see FIG. 7) may be reduced, so that display quality of the electronic device 10b may be improved.

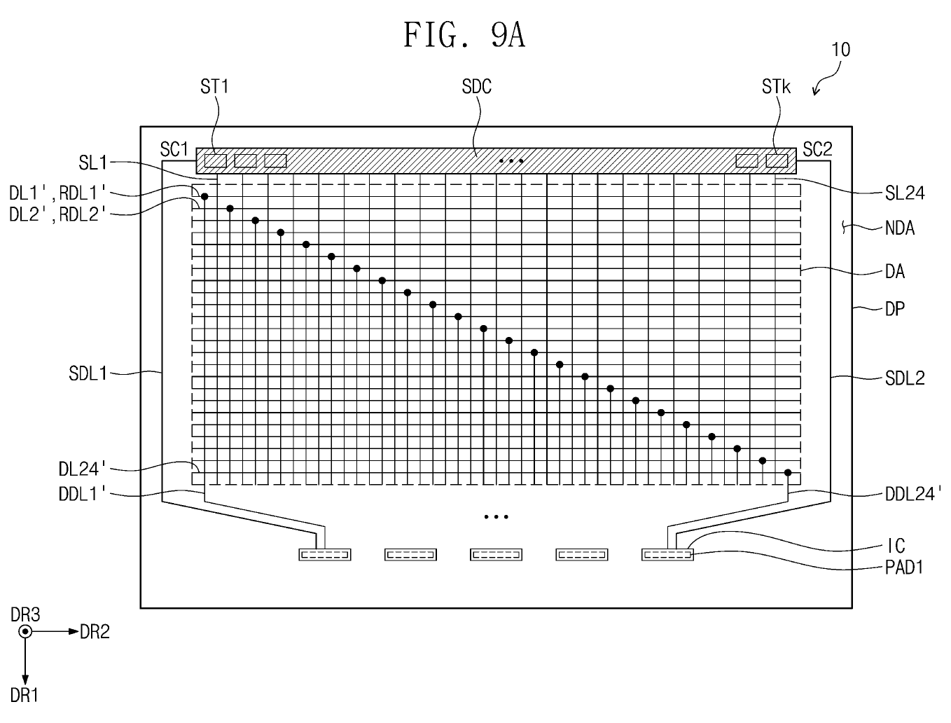

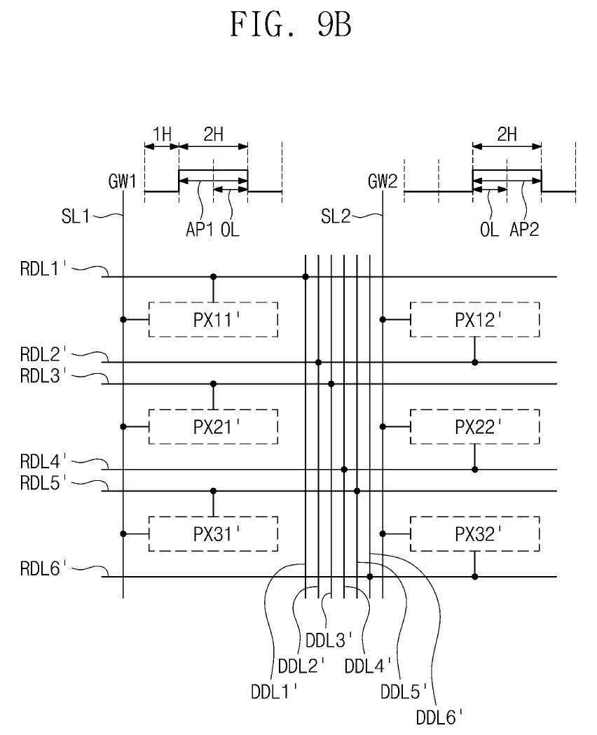

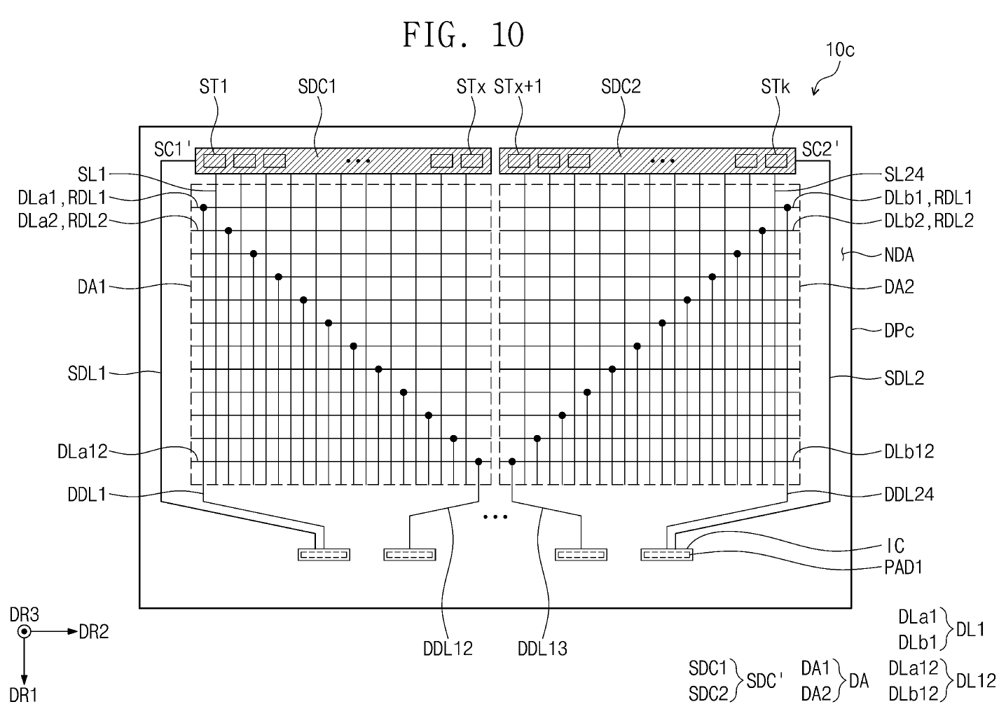

FIG. 9A is a schematic plan view of an electronic device 10 according to an embodiment of the present disclosure. In FIG. 9A, the same components as those in FIG. 8A are denoted by the same reference numerals, and the description thereof is omitted. In FIG. 9A, differences from FIG. 8A will be mainly described. Although the example embodiment of FIG. 9A illustrates a case where the display panel DP includes 24 scan lines SL1 to SL24, 24 data lines DL1′ to DL24′, and 24 data supply lines DDL1′ to DDL24′, the number of the scan lines SL1 to SL24, the data lines DL 1′ to DL 24′, and the data supply lines DLD1′ to DDL24′ is not limited thereto.

Referring to FIGS. 5 and 9A, the data lines DL1′ to DL24′ may be electrically connected to corresponding pixels of the pixels PX.

In an embodiment of the present disclosure, the data lines DL1′ to DL24′ may include a first row data line RDL1′ and a second row data line RDL2′. For example, a first data line DL1′ among the data lines DL1′ to DL24′ may be referred to as a first row data line RDL1′, and a second data line DL2′ among the data line DL1′ to DL24′ may be referred to as a second row data line RDL2′.

In an embodiment of the present disclosure, the first row data line RDL1′ and the second row data line RDL2′ may be electrically connected to pixels PX arranged in the same row as each other. For example, the first data line DL1′ among the data lines DL1′ to DL24′ may be electrically connected to pixels arranged in the odd-numbered columns among the pixels PX arranged in the first row. The second data line DL2′ among the data lines DL1′ to DL24′ may be electrically connected to pixels arranged in the even-numbered columns among the pixels PX arranged in the first row. In addition, a last data line DL24′ among the data lines DL1′ to DL24′ may be electrically connected to pixels arranged in the even-numbered columns of the pixels PX arranged in the last row. Hereinafter, the pixels arranged in the odd-numbered columns among the pixels PX arranged in the first row may be referred to as a plurality of first pixels PX11′ (see FIG. 9B), and the pixels arranged in the even-numbered columns of the pixels PX arranged in the first row may be referred to as a plurality of second pixels PX12′ (see FIG. 9B).

According to the present disclosure, some of the pixels PX arranged in one row may be electrically connected to the first row data line RDL1′, and the remaining ones of the pixels PX arranged in the one row may be electrically connected to the second row data line RDL2′. Therefore, since the pixels PX arranged in the one row are electrically connected to the two data lines RDL1′ and RDL2′ alternately, it is possible to ensure a time for charging the data voltage to the pixels PX even if the display panel DP is driven at a high speed at a frequency of 240 Hz or higher.

In addition, according to the present disclosure, the data lines DL1′ to DL24′ may extend in the second direction DR2 that is a horizontal direction of the display area DA, and may be arranged in the first direction DR1 that is a vertical direction of the display area DA. Since a width of the display area DA in the first direction DR1 is smaller than a width of the display area DA in the second direction DR2, the number of data lines DL1′ to DL24′ may be reduced compared to being arranged in the second direction DR2, that is the horizontal direction. As the number of data lines DL1′ to DL24′ decreases, the size or the number of the driving chips IC including the data driving circuit IC that outputs data voltages to the data lines DL1′ to DL24′ may decrease, and thus, the manufacturing cost of the electronic device 10 including the driving chips IC may be reduced.

In an embodiment of the present disclosure, the data supply lines DDL1′ to DDL24′ may be electrically connected to the data lines DL1′ to DL24′ in a one-to-one correspondence. The data supply lines DDL1′ to DDL24′ may be arranged in the second direction DR2. The data supply lines DDL1′ to DDL24′ may be sequentially shortened in length in the second direction DR2. For example, the data supply line DDL1′ on one side (for example, the data supply line arranged first in the second direction DR2) among the data supply lines DDL1′ to DDL24′ may be electrically connected to the first data line DL1′ arranged at the top of the display panel DP, and the data supply line DDL24′ on the other side (for example, the data supply line arranged last in the second direction DR2) of the data supply lines DDL1' to DDL24' may be electrically connected to the data line DL24′ arranged at the bottom of the display panel DP.

FIG. 9B is a diagram illustrating a connection relationship between some pixels PX according to an example embodiment of the present disclosure. In FIG. 9B, six pixels PX11′, PX12′, PX21′, PX22′, PX31′, and PX32′ are illustrated as an example.

Referring to FIGS. 5, 9A, 9B, the pixels PX may include first to sixth pixels PX11′, PX12′, PX21′, PX22′, PX31′, and PX32′. The first pixel PX11′ may be electrically connected to the first row data line RDL1′ and the first column scan line SL1, the second pixel PX12′ may be electrically connected to the second row data line RDL2′ and the second column scan line SL2, the third pixel PX21′ may be electrically connected to the third row data line RDL3′ and the first column scan line SL1 and the fourth pixel PX22′ may be electrically connected to the fourth row data line RDL4′ and the second column scan line SL2 and the fifth pixel PX31′ may be electrically connected to the fifth row data line RDL5′ and the first column scan line SL1, and the sixth pixel PX32′ may be electrically connected to the sixth row data line RDL6′ and the second column scan line SL2.

In an embodiment of the present disclosure, the first data supply line DDL1′ may be electrically connected to the first row data line RDL1′, the second data supply line DDL2′ may be electrically connected to the second row data line RDL2′, and the third data supply line DDL3′ may be electrically connected to the third row data line RDL3′. The fourth data supply line DDL4′ may be electrically connected to the fourth row data line RDL4′, the fifth data supply line DDL5′ may be electrically connected to the fifth row data line RDL5′, and the sixth data supply line DLD6′ may be electrically connected to the sixth row data line RDL6′.

In an embodiment of the present disclosure, each of the first to sixth row data lines RDL1′, RDL2′, RDL3′, RDL4′, RDL5′, and RDL6′ may be electrically connected to corresponding pixels PX. For example, the first row data line RDL1′ may be electrically connected to the first pixel PX11′ arranged in the odd-numbered columns among the pixels PX11′ and PX12′ arranged in the first row, and the second row data line RDL2′ may be electrically connected to the second pixel PX12′ arranged in the even-numbered columns among the pixels PX11′ and PX12′ arranged in the first row. In addition, the third row data line RDL3′ may be electrically connected to the third pixels PX21′ arranged in the odd-numbered columns among the pixel PX21′ and PX22′ arranged in the second row, and the fourth row data line RDL4′ may be electrically connected to the fourth pixel PX22′ arranged in the even-numbered columns of the pixels PX21′ and PX22′ arranged in the second row.

According to the present disclosure, some of the pixels PX arranged in one row may be electrically connected to the first row data line RDL1′, and the remaining ones of the pixels PX arranged in the one row may be electrically connected to the second row data line RDL2′. For example, data voltages through the first row data line RDL1′ may be applied to the pixels PX11′ connected to the first row data lines RDL1′ in a first activation period AP1 of the first write scan signal GW1 provided to the first column scan line SL1, and data voltages through the second row data line RDL2′ may be applied to the pixels PX12′ connected to the second row data lines RDL2′ in a second activation period AP2 of the second write scan signal GW2 provided to the second column scan line SL2.

In an embodiment of the present disclosure, the first activation period AP1 of the first write scan signal GW1 provided to the first column scan line SL1 and the second activation period AP2 of the second write scan signal GW2 provided to the second column scan line SL2 may overlap each other in some periods OL. For example, a length of each of the first and second activation periods AP1 and AP2 may be two horizontal periods 2H, and a length of some periods OL may be one horizontal period 1H. Therefore, since the pixels PX arranged in one row are alternately electrically connected to the two data lines RDL1′ and RDL2′, it is possible to ensure time for charging the data voltages to the pixels PX even if the display panel DP is driven at a high speed at a frequency of 240 Hz or higher.

FIG. 10 is a schematic plan view of an electronic device 10c according to an embodiment of the present disclosure. In FIG. 10, the same components as those in FIG. 8A are denoted by the same reference numerals, and the description thereof is omitted. In FIG. 10, differences from FIG. 8A will be mainly described.

Referring to FIGS. 5 and 10, a scan driving circuit SDC′ may include a first scan driving circuit SDC1 and a second scan driving circuit SDC2.

In an embodiment of the present disclosure, the first scan driving circuit SDC1 may be electrically connected to the first scan control line SDL1, and the second scan driving circuit SCD2 may be electrically connected to the second scan control line SDL2. The first scan driving circuit SDC1 and the second scan driving circuit SCD2 may be electrically isolated.

In an embodiment of the present disclosure, the first scan control line SDL1 may receive a first scan control signal SC1′, and the second scan control line SDL2 may receive a second scan control signal SC2′. The first scan control signal SC1′ may be a signal for controlling the first scan driving circuit SDC1 that controls operations of the pixels PX arranged in the first display area DA1, and the second scan control signal SC2′ may be a signal for controlling the second scan driving circuit SCD2 that controls operations the pixels PX arranged in the second display area DA2.

In an embodiment of the present disclosure, the first scan driving circuit SDC1 may include a plurality of first stages ST1 to STx, and the second scan driving circuit SDC2 may include a plurality the second stages STx+1 to STk. The first stages ST1 to STx may be sequentially driven from the first stage ST1 to the x-th stage STx, and the second stages STx+1 to STk may be sequentially driven from the (x+1)-th stage STx+1 to the k-th stage STk.

According to the present disclosure, the first scan driving circuit SDC1 and the second scan driving circuit SDC2 may individually drive the first display area DA1 and the second display area DA2, respectively. Therefore, the first scan driving circuit SDC1 and the second scan driving circuit SDC2 may use the first display area DA1 and the second display area DA2 as a full screen or a split screen. For example, the first scan driving circuit SDC1 and the second scan driving circuit SDC2 may receive the first scan control signal SC1′ and the second scan control signal SC2′ having the same timing, respectively. Accordingly, the first display area DA1 and the second display area DA2 may be used as a full screen.

In addition, the first scan driving circuit SDC1 and the second scan driving circuit SDC2 may receive first scan control signals SC1′ and second scan control signals SC2′ having different timings, respectively. Accordingly, the first display area DA1 and the second display area DA2 may be used as a split screen.

For example, four driving chips ICs may be mounted on the display panel DPc. When only the first display area DA1 of the display panel DPc is driven, only some driving chips that output data voltages to the first display area DA1 among the driving chips IC are activated, and the remaining driving chips IC and the second scan driving circuit SDC2 may be deactivated. In this case, power consumption of the electronic device 10c may be reduced. However, the present disclosure is not limited thereto, and one driving chip IC may output data voltages to both the first display area DA1 and the second display area DA2. When only the first display area DA1 of the display panel DPc is driven, the one driving chip IC is activated, and some driving chips that output data voltages only in the second display area DA2 may be deactivated.

In addition, a frequency of the first scan control signal SC1′ and a frequency of the second scan control signal SC2′ may be different from each other. Therefore, the first display area DA1 may be driven at a first frequency, and the second display area DA2 may be driven at a second frequency different from the first frequency.

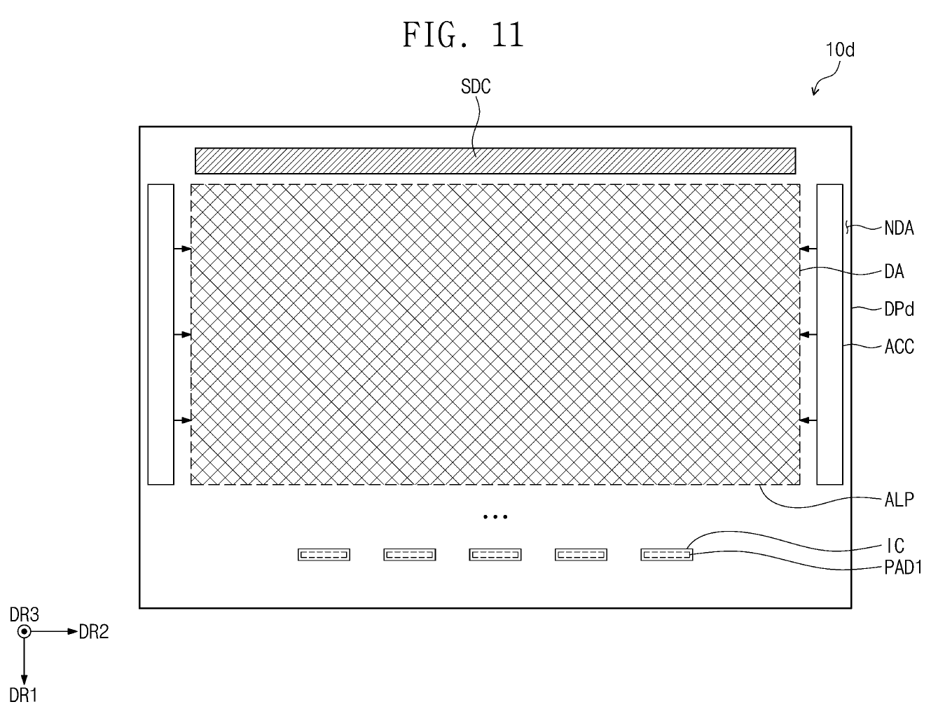

FIG. 11 is a schematic plan view of an electronic device 10d according to an embodiment of the present disclosure.

Referring to FIGS. 5, 7, and 11, a display panel DPd may further include an additional circuit ACC. The additional circuit ACC may be disposed in the non-display area NDA in the second direction DR2 from the display area DA.

In an embodiment of the present disclosure, the additional circuit ACC may include an electrostatic protection circuit. The electrostatic protection circuit may be a circuit for preventing damage to each of the data lines DL1 to DLm due to electrostatic discharge. The electrostatic protection circuit may be connected to a ground voltage, and may stabilize the voltage through the electrostatic protection circuit when an outlier voltage is applied to each of the data lines DL1 to DLm. The electrostatic protection circuit may include, for example, a diode.

In an embodiment of the present disclosure, the additional circuit ACC may further include a plurality of matching capacitors. The matching capacitors may be electrically connected to at least some of the data lines DL1 to DLm. The matching capacitors may be configured to compensate data voltages of each of the data lines DL1 to DLm to be uniform.

In an embodiment of the present disclosure, the additional circuit ACC may output a plurality of driving voltages ELVDD, ELVSS, and VINT to the pixels PX arranged in the display area DA. In an embodiment, the driving voltages ELVDD, ELVSS, and VINT may include the first driving voltage ELVDD, the second driving voltage ELVSS, and the initialization voltage VINT.

In an embodiment of the present disclosure, the display panel DPd may further include an auxiliary pattern ALP. The auxiliary pattern ALP may be electrically connected to one of the first to third driving voltage lines VL1, VL2, and VL3 that output the driving voltages ELVDD, ELVSS, and VINT, respectively. Voltage drops of the driving voltages ELVDD, ELVSS, and VINT may be reduced by the auxiliary pattern ALP. Accordingly, the driving voltages ELVDD, ELVSS, and VINT may be provided to the pixels PX uniformly.

The auxiliary pattern ALP may be disposed in the display area DA. The auxiliary pattern ALP may have a mesh structure. A plurality of openings may be defined on the auxiliary pattern ALP, and the plurality of openings may overlap the light-emitting area. However, the present disclosure is not limited thereto, and some of the auxiliary pattern ALP may overlap the display area DA, and the other portions of the auxiliary pattern ALP may overlap the non-display area NDA.

According to the present disclosure, the data driving circuit IC and the scan driving circuit SDC may be disposed on the upper side or the lower side of the display panel DPd. Accordingly, an additional circuit ACC including an electrostatic protection circuit for improving display quality, matching capacitors, and first to third driving voltage lines VL1, VL2, and VL3 may be disposed in the non-display area NDA on the left side and the right side of the display panel DPd. Accordingly, the display quality of the electronic device 10d may be improved.

Although the present display device has been described with reference to the embodiments shown in the drawings, these are merely exemplary, and those skilled in the art will understand that various modifications and equivalent other embodiments are possible therefrom. Therefore, the disclosed subject matter should not be limited to any single embodiment described herein.

What is claimed is:

1. An electronic device comprising:
a display panel comprising a display area and a non-display area; and
a data driving circuit electrically connected to the display panel,
wherein the display panel includes:
a plurality of pixels arranged in the display area;
a scan driving circuit arranged in the non-display area and spaced apart from the data driving circuit in a first direction;
a plurality of scan lines extending from the scan driving circuit in the first direction, the plurality of scan lines being arranged so that each scan line of the plurality of scan lines is spaced apart in a second direction intersecting the first direction;
a plurality of data lines extending in the second direction, the plurality of data lines being arranged so that each data line of the plurality of data lines is spaced apart in the first direction;
a plurality of data supply lines extending in parallel with the first direction and electrically connected in one-to-one correspondence with the plurality of data lines;
a first scan control line electrically connected to one end of the scan driving circuit; and
a second scan control line electrically connected to the other end of the scan driving circuit.

2. The electronic device of claim 1, wherein each data supply line of the plurality of data supply lines is configured to transfer a respective data voltage of the plurality of data voltages output from the data driving circuit to a corresponding data line of the plurality of data lines.

3. The electronic device of claim 1, wherein the first scan control line is configured to receive a first scan control signal, and the second scan control line is configured to receive a second scan control signal; and
wherein the first scan control signal and the second scan control signal are a same scan control signal.

4. The electronic device of claim 1, wherein:
the display area includes:
a first display area; and
a second display area arranged in the second direction from the first display area, and
the plurality of data lines include:
a plurality of first data lines arranged in the first display area; and
a plurality of second data lines arranged in the second display area; and
the plurality of first data lines and the plurality of second data lines are electrically isolated from each other.

5. The electronic device of claim 4, wherein:
the plurality of data supply lines include:
a plurality of first data supply lines electrically connected in one-to-one correspondence with the plurality of first data lines; and
a plurality of second data supply lines electrically connected in one-to-one correspondence with the plurality of second data lines.

6. The electronic device of claim 4, wherein:
the scan driving circuit includes:
a first scan driving circuit electrically connected to the first scan control line; and
a second scan driving circuit electrically connected to the second scan control line, and
the first scan driving circuit and the second scan driving circuit are electrically isolated from each other.

7. The electronic device of claim 6, wherein:
the first scan control line is configured to receive a first scan control signal,
the second scan control line is configured to receive a second scan control signal,
the first scan control signal controls the first scan driving circuit, and the first scan driving circuit controls operations of the plurality of pixels arranged in the first display area, and
the second scan control signal controls the second scan driving circuit, and the second scan driving circuit controls operations of the plurality of pixels arranged in the second display area.

8. The electronic device of claim 1, wherein:
the plurality of data lines include a first row data line and a second row data line, and
the plurality of pixels include:
a plurality of first row pixels electrically connected to the first row data line; and
a plurality of second row pixels electrically connected to the second row data line.

9. The electronic device of claim 1, wherein:
the plurality of data lines include a first row data line and a second row data line,
the plurality of pixels include:
a plurality of first pixels electrically connected to the first row data line; and
a plurality of second pixels electrically connected to the second row data line, and
the plurality of first pixels and the plurality of second pixels are arranged in a same row.

10. The electronic device of claim 1, wherein the first scan control line and the second scan control line are electrically connected to the data driving circuit and are configured to receive, from the data driving circuit, a plurality of scan control signals for controlling the scan driving circuit that controls operations of the plurality of pixels.

11. The electronic device of claim 1, further comprising:
a circuit board electrically connected to the display panel; and
a control circuit mounted in the circuit board and configured to output a plurality of scan control signals for controlling the scan driving circuit that controls operations of the plurality of pixels,
wherein the first scan control line and the second scan control line are electrically connected to the control circuit and are configured to receive the plurality of scan control signals from the control circuit.

12. The electronic device of claim 1, wherein a width of the display area in the first direction is smaller than a width of the display area in the second direction.

13. The electronic device of claim 1, wherein the display panel further includes an additional circuit arranged in the non-display area in the second direction from the display area.

14. The electronic device of claim 1, wherein:
each of the plurality of pixels includes a pixel circuit and a light-emitting element electrically connected to the pixel circuit, and
the plurality of data supply lines are arranged, spaced apart in the second direction, so as not to overlap with an area in which the pixel circuit is disposed.

15. An electronic device comprising:
a display panel in which a display area and a non-display area are defined; and
a processor configured to control an operation of the display panel,
wherein the display panel includes:
a plurality of pixels arranged in the display area;
a scan driving circuit arranged in the non-display area;
a plurality of scan lines extending from the scan driving circuit in a first direction, the plurality of scan lines being arranged so that each scan line of the plurality of scan lines is spaced apart in a second direction intersecting the first direction;
a plurality of data lines extending in the second direction, the plurality of data lines being arranged so that each data line of the plurality of data lines is spaced apart in the first direction;
a plurality of data supply lines extending in parallel with the first direction and electrically connected in one-to-one correspondence with the plurality of data lines;
a first scan control line electrically connected to one end of the scan driving circuit; and
a second scan control line electrically connected to the other end of the scan driving circuit,
wherein the display area includes:
a first display area; and
a second display area arranged in the second direction from the first display area, and
wherein the plurality of data lines include a plurality of first data lines arranged in the first display area and a plurality of second data lines arranged in the second display area.

16. The electronic device of claim 15, wherein:
the plurality of first data lines and the plurality of second data lines are electrically isolated from each other,
the plurality of data supply lines include:
a plurality of first data supply lines electrically connected in one-to-one correspondence with the plurality of first data lines; and
a plurality of second data supply lines electrically connected in one-to-one correspondence with the plurality of second data lines.

17. The electronic device of claim 15, wherein:
the first scan control line is configured to receive a first scan control signal, and the second scan control line is configured to receive a second scan control signal, and
the first scan control signal and the second scan control signal are a same signal.

18. The electronic device of claim 15, wherein:
the scan driving circuit includes:
a first scan driving circuit electrically connected to the first scan control line; and
a second scan driving circuit electrically connected to the second scan control line,
the first scan driving circuit and the second scan driving circuit are electrically isolated from each other,
the first scan control line is configured to receive a first scan control signal, and the second scan control line is configured to receive a second scan control signal,
the first scan control signal controls the first scan driving circuit, and the first scan driving circuit controls operations of the plurality of pixels arranged in the first display area, and
the second scan control signal controls the second scan driving circuit, and the second scan driving circuit controls operations of the plurality of pixels arranged in the second display area.

19. The electronic device of claim 15, wherein:
the plurality of data lines include a first row data line and a second row data line, and
the plurality of pixels include:
a plurality of first row pixels electrically connected to the first row data line; and
a plurality of second row pixels electrically connected to the second row data line.

20. The electronic device of claim 15, wherein:
the plurality of data lines include a first row data line and a second row data line,
the plurality of pixels include:
a plurality of first pixels electrically connected to the first row data line; and
a plurality of second pixels electrically connected to a second row data line, and
the plurality of first pixels and the plurality of second pixels are arranged in a same row.
